(19) United States
(12) Patent Application Publication
(10) Pub. No.: US 2026/0027957 A1
(43) Pub. Date: Jan. 29, 2026

(54) PART FOR A VEHICLE SEAT AND METHOD OF MAKING THE PART

(71) Applicant: Adient US LLC, Plymouth, MI (US)

(72) Inventors: Joseph RAJKUMAR, Ypsilanti, MI (US); Allison PARRIS, Farmington, MI (US); Michael APOSTOLOVSKI, Farmington, MI (US); Samantha BYTNAR, Perrysburg, OH (US)

(21) Appl. No.: 19/280,325

(22) Filed: Jul. 25, 2025

Related U.S. Application Data
(60) Provisional application No. 63/676,689, filed on Jul. 29, 2024.

(51) Int. Cl. B60N 2/68; B60N 2/36; B60N 2/58

(52) U.S. Cl. CPC B60N 2/686; B60N 2/5883; B60N 2/36

(57) ABSTRACT

A part for a seat may have a base material comprised of a flexible, non-woven material. The base material may have a polymeric coating on at least part of the base material. A trim piece may be sewn to the coated base material.

### FIELD

This disclosure relates to a part of a vehicle, including but not limited to, a motor vehicle. The part may be associated with a seat in the vehicle.

### BACKGROUND

Vehicles are used for many applications, many of which may result in delicate or hard-to-clean components becoming dirty or damaged. The seats are one example of such components. More particularly, the rear or back surfaces of seats are often neglected in the design process and are covered with basic fabrics that easily and readily collect dirt and damage. In view of the disadvantages associated with known seats, it would be advantageous to have a seat surface that rejects dirt and is robust enough to deflect or survive damage.

### SUMMARY

To be completed when the claims are finalized

### BRIEF DESCRIPTION OF THE DRAWINGS

The above, as well as other advantages, will become readily apparent to those skilled in the art from the following detailed description when considered in the light of the accompanying drawings in which:

FIG. 1 schematically depicts a perspective view of a vehicle;

FIG. 2 schematically depicts a top cut away view of the vehicle from FIG. 1;

FIG. 3 schematically depicts a seat from the vehicle in a first condition;

FIG. 4 schematically depicts the seat in a second condition;

FIG. 5 schematically depicts steps in a process for making a part for a vehicle seat;

FIG. 6 schematically depicts steps in a process for making a part for a vehicle seat;

FIG. 7 schematically depicts steps in a process for making a part for a vehicle seat;

FIG. 8 schematically depicts steps in a process for making a part for a vehicle seat;

FIG. 9A schematically depicts a plan view of a part for a vehicle seat;

FIG. 9B schematically depicts an end view of the part for a vehicle seat of FIG. 9A;

FIG. 9C schematically depicts a side view of the part for a vehicle seat of FIG. 9A;

FIG. 9D schematically depicts a perspective view of the part for a vehicle seat of FIG. 9A;

FIG. 9E1 schematically depicts a perspective view of a part for a vehicle seat;

FIG. 9E2 schematically depicts a detail of the part for the vehicle seat of FIG. 9E1;

FIG. 9E3 schematically depicts a side view of part for the vehicle seat of FIG. 9E1;

FIG. 9F schematically depicts a detail of FIG. 9A;

FIG. 9G1 schematically depicts a detail of FIG. 9A;

FIG. 9G2 schematically depicts a detail of FIG. 9A;

FIG. 10 schematically depicts a partial cut-away side view of a part for a vehicle seat connected to a frame;

FIG. 11 schematically depicts pieces of seat trim and the part for the vehicle seat;

FIG. 12 schematically depicts uninstalled seat trim;

FIG. 13 schematically depicts a part for a vehicle seat on the seat trim of FIG. 12;

FIG. 14 schematically depicts an interior side of the part for a vehicle seat connected to the seat trim;

FIG. 15 schematically depicts an exterior of the part for a vehicle seat connected to the seat trim;

FIG. 16 schematically depicts a zipper closure for the seat trim;

FIG. 17 schematically depicts a corner of part for a vehicle seat;

FIG. 18 schematically depicts a part for a vehicle seat;

FIG. 19 schematically depicts a corner of a part for a vehicle seat;

FIG. 20 schematically depicts a part for a vehicle seat;

FIG. 21 schematically depicts a part for a vehicle seat;

FIG. 22 schematically depicts a corner of a part for a vehicle seat;

FIG. 23 schematically depicts a portion of a part for a vehicle seat;

FIG. 24 schematically depicts the part for a vehicle seat connected to a trim piece; and

FIG. 25 schematically depicts an image in a part for a vehicle seat.

### DETAILED DESCRIPTION

It is to be understood that the device may assume various alternative orientations and step sequences, except where expressly specified to the contrary. It is also to be understood that the specific devices and processes illustrated in the attached drawings, and described in the following specification are simply exemplary embodiments. Hence, specific dimensions, directions or other physical characteristics relating to the embodiments disclosed are not to be considered as limiting, unless expressly stated otherwise.

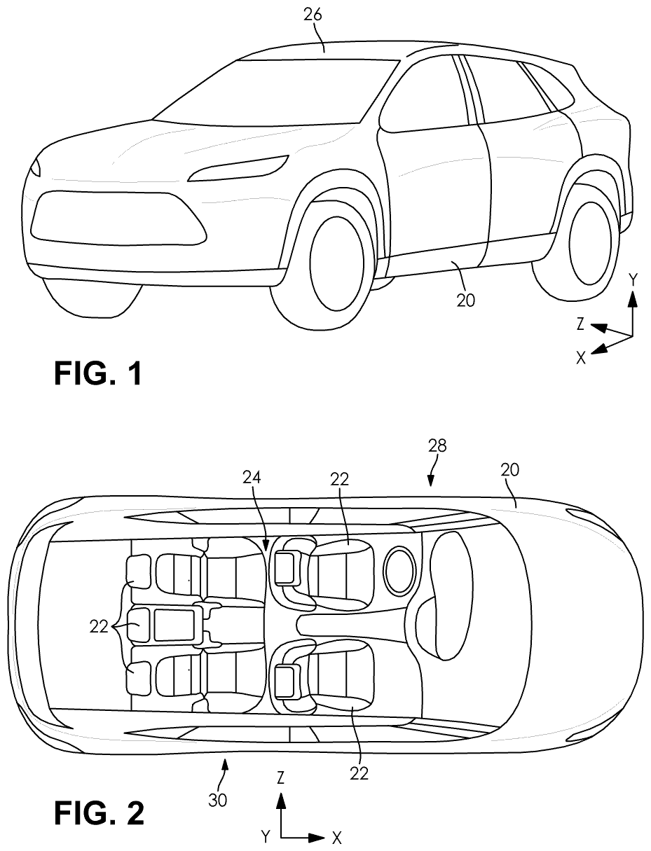

FIGS. 1-2 schematically depict a vehicle 20, such as a motor vehicle. While one vehicle 20 is depicted, vehicles of other shapes, sizes and configurations may be used. Seats 22 may be located on an interior 24 of the vehicle 20. Here also, while a certain number, type, location and orientation of seats 22 are schematically depicted other variations are permissible including seats 22 turned in different directions.

A coordinate system is provided where an X direction is generally associated with the forward direction of the vehicle 20; the X direction may also be associated with the longitudinal axis of the vehicle 20. A Y direction may be associated with a direction transverse the X direction such as extending vertically from the ground through a roof 26 of the vehicle 20. A Z direction may be transverse both the X and Y directions and may extend laterally from one side of the vehicle 20 to the other side of the vehicle 20, such as from a road side 28 to a curb side 30 of the vehicle 20.

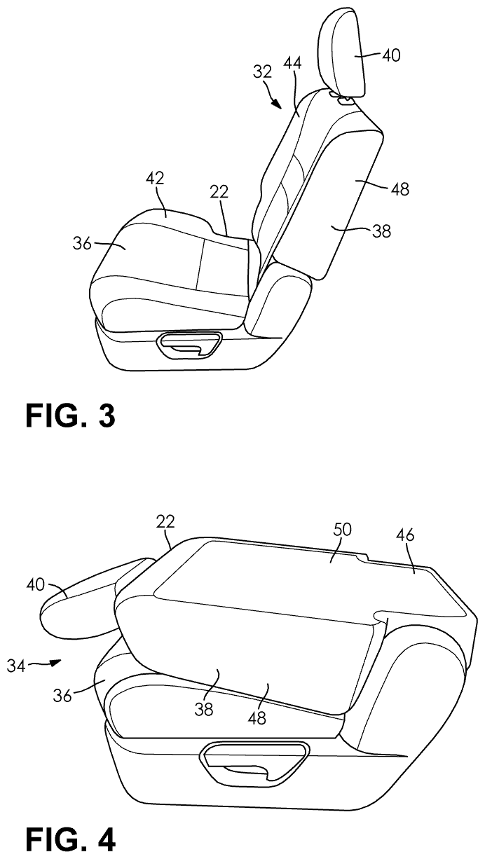

FIGS. 3 and 4 schematically depict a seat 22 from FIG. 2 in different positions, where the different positions comprise at least one of an upright, use position 32 and a non-use position 34. While two positions 32, 34 of the seat 22 are shown, the seat 22 may have other positions. Further, the seat 22 may be of different sizes and shapes and combinations of features.

The seat 22 may comprise a seat pan portion 36 and a back-rest portion 38. Optionally, the seat 22 comprises a headrest 40. The backrest portion 38 may be adjustable, including pivotable, relative to the seat pan portion 36 to move between the use 32 and non-use position 34. Further, the headrest 40 may be adjustable relative to the backrest portion 38.

The upright, use position 32 may provide a seating surface 42 to a seat occupant. The upright, use position 32 may be one of a comfort seating position. The non-use position 34 may be a position in which the backrest portion 38 is folded down, such as towards the seat pan portion 36, providing a substantially or generally flat surface. Usually, an occupant cannot reside in the seat 22 while it is in the non-use position 34.

The backrest portion 38 may be comprised of a front portion 44, a back portion 46 and side portions 48 between the front and back portions 44, 46.

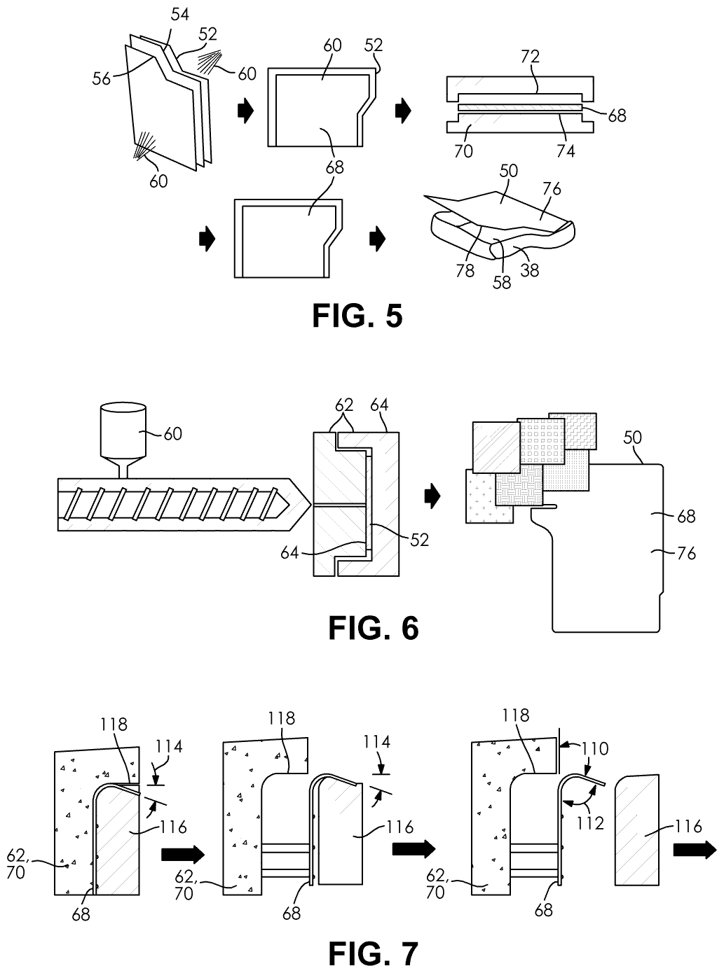

The back portion 46 may be comprised of a back panel 50. The back panel 50 may be comprised of a base material 52 schematically shown in FIG. 5. The base material 52 may be any material that is soft enough to be sewn using a standard industrial sewing machine, but strong enough to routinely experience normal tensile, compression, and sheer stresses associated with a vehicle interior part, such as for a seat, without significant loss of structural or functional integrity. The base material 52 may have a density of approximately 60-80 g/m².

The base material 52 may be at least partially constructed of a flexible, non-woven material. Non-woven materials may be materials that are created by bonding small fibers together to create a fabric-like material. The fibers may be bonded together by adhesives, heat, or mechanical means. Non-woven materials may be formed in flat, porous sheets that are made from the above-mentioned fibers or from molten plastic or film. Usually, they are not made by weaving or knitting and they usually do not require converting the fibers to yarn. Non-woven materials may be made from a variety of materials, including polyester, nylon, and acrylic. They can be made from natural or synthetic fibers, and they may be used in combination with other materials. Non-woven materials may comprise meshes and felts. One characteristic of a non-woven material is that the fibers may not be aligned together or connected together at regular intervals. Instead, the non-woven material may be a chaotic, random assortment of fibers of different sizes, shapes and orientations. In one case, the non-woven material may be such as Duon Brand 4.1 oz black material. The non-woven material may be tear resistant.

Due to its flexibility, the shape of the base material 52 may be adapted to conform to the size, shape and contours of the location in which it is placed. The base material 52 may be adapted to fit the back portion 46 of the seat 22 or other portions of the seat 22 or vehicle 20 as schematically depicted in the figures.

The base material 52 may have an interior side 54 and an exterior side 56. The interior side 54 may face an interior portion 58 of the back-rest portion 38, as schematically shown in FIG. 5. The exterior side 56 may be opposite the interior side 54 and face the interior 24 of the vehicle 20 and/or a seat occupant. The interior and exterior sides 54, 56 may define a constant or variable thickness between them.

A coating 60 may be applied to the base material 52. The coating 60 may be applied to both the interior and exterior sides 54, 56 or only one side 54 or 56, and the coating 60 may be applied to any side 54, 56 entirely or only partially. When the coating 60 is a liquid, it may be applied to the base material 52 by spraying as schematically depicted in FIG. 5. It may be preferred to apply the same amount of coating 60 entirely across both sides 54, 56 of the base material 52.

The coating 60 may also be applied to the base material 52 by locating the base material 52, in whole or in part, into a mold 62 and then injecting the coating 60, which may be in the form of a resin, into the mold 62 such that it contacts the base material 52, as schematically depicted in FIG. 6.

The mold 62 may have surfaces 64 that define the interior 66 of the mold 62. There may be a design in the interior surfaces 64 of the mold 62 that contacts at least the resin and imparts into the resin, in whole or in part, a texture and/or graining, as described below. The volume of resin per square millimeter may range from 500 mm³ and 2000 mm³.

The coating 60 may be applied to the base material 52 such that the coating 60 creates a skin on the base material of approximately 0.5 mm to approximately 2 mm thick; the skin may be approximately 1 mm thick substantially across the entire base material 52. The coated base material 68 may be approximately 1.9-10 mm thick. The thickness of the coated base material 68 may vary. The thickness and robustness of the coated base material 68 may be such that a commercial sewing machine using a #19 to #23 needle can extend thread through the coated base material 68. The coating 60 may have no negative effect on the flexibility of the base material 52.

The coating 60 may be such as a polymer. The polymer may include polyurethane. The polymer may comprise a thermoset or a thermoplastic material. While a polymer is mentioned, any material that may be at least partially dirt/debris/dust and/or moisture repellent may be used. The coated base material 68 may be cleaned by wiping with a cloth or the like.

If the base material 52 is to be sprayed with the coating 60, as schematically depicted in FIG. 5, the coated base material 68 may be placed into a mold 70 with an upper interior surface 72 and a lower interior surface 74. There may be a design in one or both interior surfaces 72, 74 of the mold 70 that contacts the coated base material 68 and gives at least one side of the coated base material 68, in whole or in part, a texture and/or graining.

While use of a mold 70 is mentioned, locating the coated base material 68 in the mold 70 is not required. Regardless of how the coated base material 68 is formed, it may be attached to an interior 24 of the vehicle 20, such as the back rest portion 44 of the seat 22.

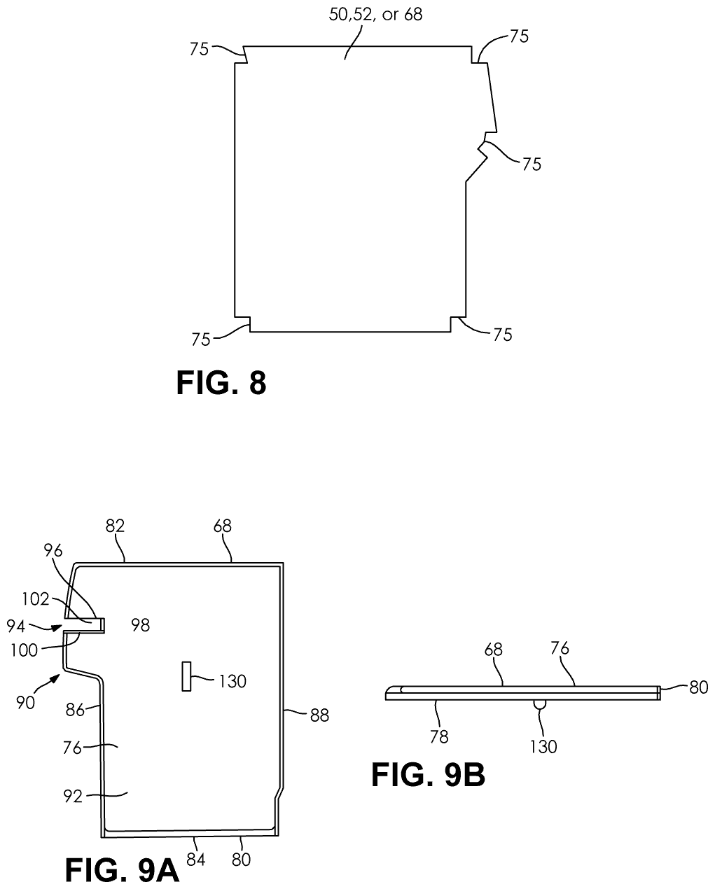

As noted, the coating 60 may be applied in whole or in part to the base material 52. So formed, the coated base material 68 may be tear, puncture and/or damage resistant. Where the non-woven material is not used, notches 75 may be intentionally formed or created to provide structural features. Alternatively, the non-woven material can be removed in selected locations to soften the product, such as for a back panel 50. Enough of the non-woven material can be removed so that the product is soft and/or pliable enough to be readily manipulated by hand for sewing, manufacture and/or installation. FIG. 8 schematically depicts a process where selected areas of the non-woven have been removed. The removed areas may be such as at the corners or other transitional areas but other areas may be removed as well.

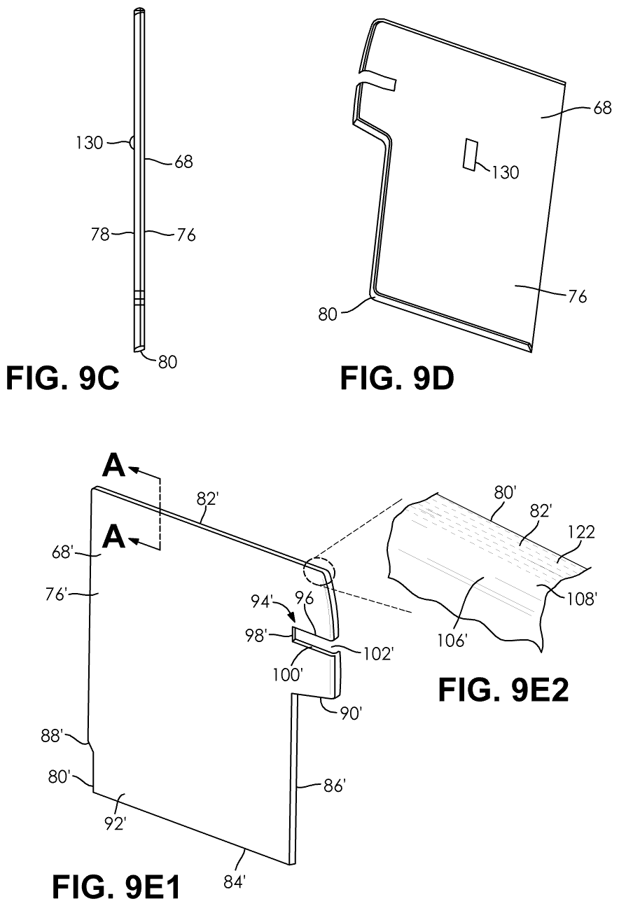

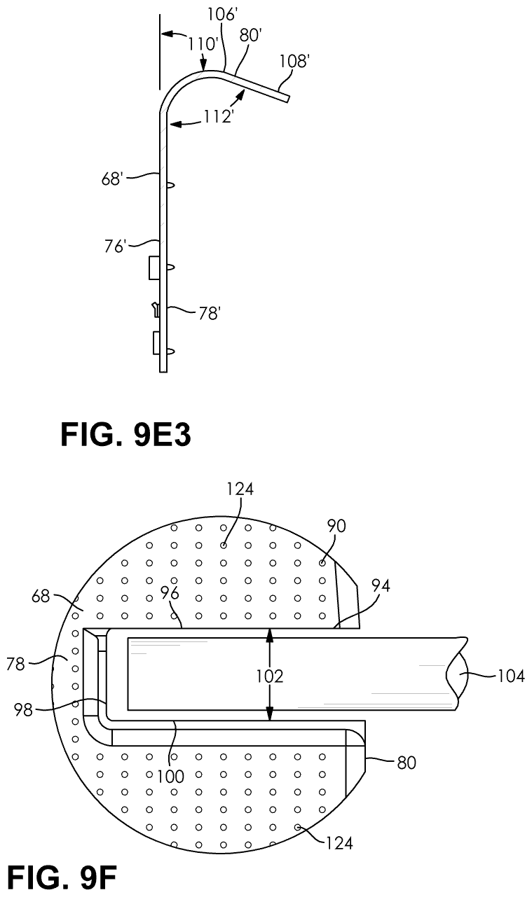

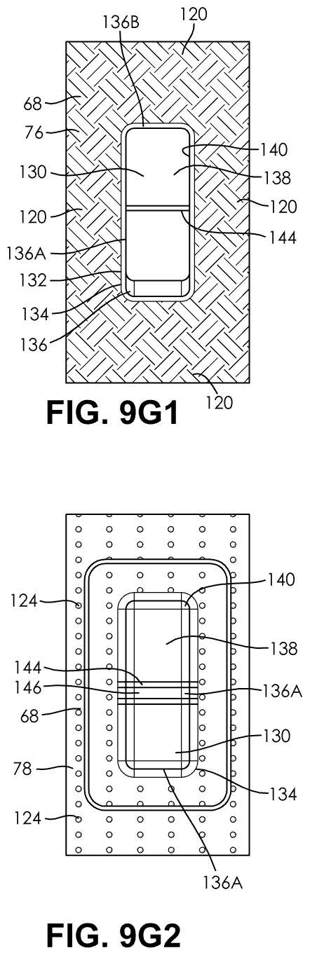

FIGS. 9A-9D schematically depict one embodiment of a coated base material 68. The coated base material 68 may have a generally polygonal shape, such as rectangular. While polygonal is mentioned, other shapes may be used. The height and/or width of the coated base material 68 may be in far excess of its thickness including larger than a factor of 10 or 100.

The coated base material 68 may have a first side 76 and a second side 78 with a perimeter edge portion 80 bounding the sides 76, 78. The perimeter edge portion 80 may be comprised of a first edge portion 82, a second edge portion 84, a third edge portion 86 and a fourth edge portion 88. The first and second edge portions 82, 84 may extend at least partially parallel one another, but they may be of unequal length. Similarly, the third and fourth edge portions 86, 88 may extend at least partially parallel one another but they may also be of unequal length. The third and fourth edge portions 86, 88 may extend generally transverse to the first and second edges 82, 84.

The third edge portion 86 may define an extension portion 90. The extension portion 90 may laterally extend a body portion 92 of the coated base material 68 thus extending the width of the body portion 92. While an extension portion 90 is noted for the third edge portion 86 it may be located in other edge portions, they may be of other sizes, shapes and locations (See for example FIG. 9E1), and there may be more than one extension portion 90. The third edge portion 86 in the extension portion 90 may have a recess portion 94 therein. The recess portion 94 may extend into the extension portion 90. Here also it may be that recess portions 94 may be located in other edge portions 82, 84, 86, or 88 and they may have different sizes, shapes and locations than noted.

The recess portion 94 may be defined by sub-portions of the third edge portion 86. The sub-portions may be comprised of first, second and third sub-edge portions 96, 98, 100. The first and third sub-edge portions 96, 100 may extend generally parallel one another and transverse to the second sub-edge portion 98. The first and third sub-edge portions 96,100 may define a gap 102 between them equivalent to the length of the second sub-edge portion 98.

The recess portion 94 may also define other shapes including a T-shape where slots may extend in a generally transverse direction from the gap 102 formed by the first and third sub-edge portions 96, 100.

The recess portion 94 may selectively receive an interior part therein. When the coated base material 68 is used as a back panel 50 for a seat 22, the recess portion 94 may receive a latch component 104 at least partially therein as schematically shown in FIG. 9F. The latch component 104 may be part of a seat adjustment and/or release system. The flexible nature of the coated base material 68 may permit it to elastically move out of the way and let the interior part push through into the recess portion 94 to be selectively positioned.

FIGS. 9E1-3 depict a related design for the coated base material 68′. Reference numbers related to the same or similar features to that disclosed herein will be used with a prime in this embodiment. The coated base material 68′ is shown to have a different size and shape compared to the previous depiction and description. In these figures, the extension portion 90′ and recess portion 94′may be on an opposite edge portion (as 86′ or 88′) for use in a different location in the vehicle 20.

As schematically depicted in FIGS. 9E1-9E2, at least a portion of the perimeter edge portion 80′ may extend away, such as downwardly, from the first side 76′. The perimeter edge portion 80′ may be comprised of a transition portion 106′ and a flange portion 108′. The transition portion 106′ may extend from the body portion 92′ and/or extension portions 90′. The transition portion 106′ may be such as a radiused transition.

The radius of the transition may be between approximately 5 mm and approximately 12 mm. The radius of the transition may be approximately 6 mm. The flange portion 108′ may be generally positioned transverse the first and/or second sides 76′, 78′.

As schematically depicted in FIGS. 9E1-3 the perimeter edge portion 80′ may extend from the first side 76′ of the body portion 92′ at an obtuse angle 110. Alternatively, the perimeter edge portion 80′ may be located at an acute angle 112 with respect to the second side 78′ of the body portion 92′.

The angle 110 or 112 of the perimeter edge portion 80, 80′ may assist in the removal of the perimeter edge portion 80, 80′, and thus the coated base material 76, 76′, from a mold 62, 70. For example, the angled nature of the perimeter edge portion 80, 80′ may lend itself to be bent away from the mold 68, 70 to remove the coated base material 76, 76′, and because of the elastic nature of the coated base material 76, 76′, the perimeter edge portions 80, 80′ may return to its original shape. FIG. 7 schematically depicts a coated base material 68 located in a mold 62, 70 with an undercut 114 and a core 116. The undercut 114, being at a different angle than the mold wall 118, facilitates release of the coated base material 68 because of their different shapes.

The perimeter edge portion 80 may extend substantially continuously and uniformly in size, shape and thickness about the coated base material 76. The perimeter edge portion 80 may have the same or different thickness than the body portion 92. The perimeter edge portion 80 may be thicker at the recess portion 94 to assist in retaining the shape of the recess portion 94.

Further, the perimeter edge portion 80 may or may not have the same or different texturing 120 than the body portion 92. The perimeter edge portion 80 may have a lighter, or less, texturing 120 than the body portion 92, such as texturing 120 that is not as high, thick and/or less dense compared to the texturing 120 on the body portion 92. Some portions of the perimeter edge portion 80 may not have any texturing 120. As such, it may be that the recess portion 94, which is part of the perimeter edge 80, has reduced or no texturing 120. Decreasing or eliminating the texture 120 has been found to assist in removing the coated base material 76 from the mold 62, 70 so that the texturing 120 does not lock or hold the coated base material 72 in the mold 62, 70. Texturing 120 is schematically depicted in FIGS. 6 and 9G1.

With continued reference to texturing 120, regardless of its type, amount or location on the coated base material 76, all of the texturing 120 may be formed on the coated base material 76 simultaneously via the molding process noted above. Thus, the texturing 120 may be simultaneously formed with the coated base material 76.

Graining 122 may be added to the perimeter edge portion 80 as schematically depicted in FIG. 9E2. Graining 122 may differ from texturing 120 in that graining 122 may be such as a pattern, or direction, of real or simulated fibers in material, such as found in wood or fabric. All the graining 122 may be formed on the coated base material 76 at the same time of formation of the coated base material 76 and texturing 120.

Texturing 120 may have a larger depth dimension than graining 122 and it may comprise geometric shapes and/or lines. Texturing 120 usually does not attempt to simulate fibers in materials. The texturing 120 may be such as a plurality of arrays of straight lines. Texturing 120 may be fine, coarse, hatched, 2-dimensional, 3-dimensional and/or patterned with a mix of raised and/or indented lines, circles, dots, and/or polygonal shapes. Both texturing 120 and graining 122 may provide an aesthetic look while ensuring a comfortable and durable surface.

FIG. 9F schematically depicts a portion of the second side 78 of the coated base material 76, such as around the recess portion 94. The second side 78 may have a plurality of extensions 124 integrally formed, unitary and one piece therewith located entirely or only partially across the second side 78. The extensions 124 may be formed at the same time as any texturing 120 or graining 122 such as via the molding processes noted above. The extensions 124 may be located in the base material 52 and/or the extensions 124 may be formed from the coating 60.

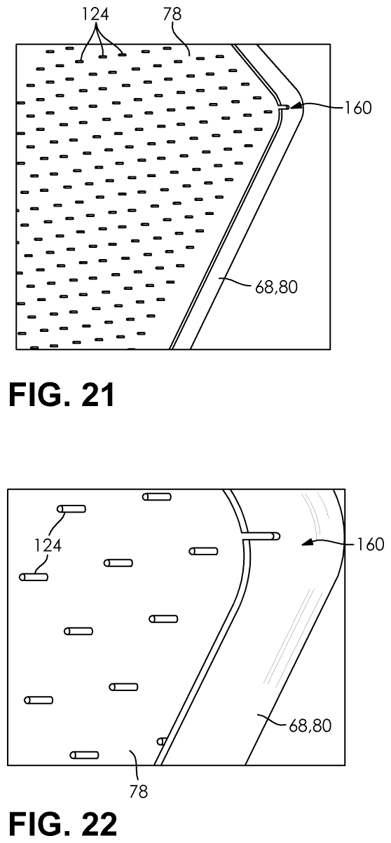

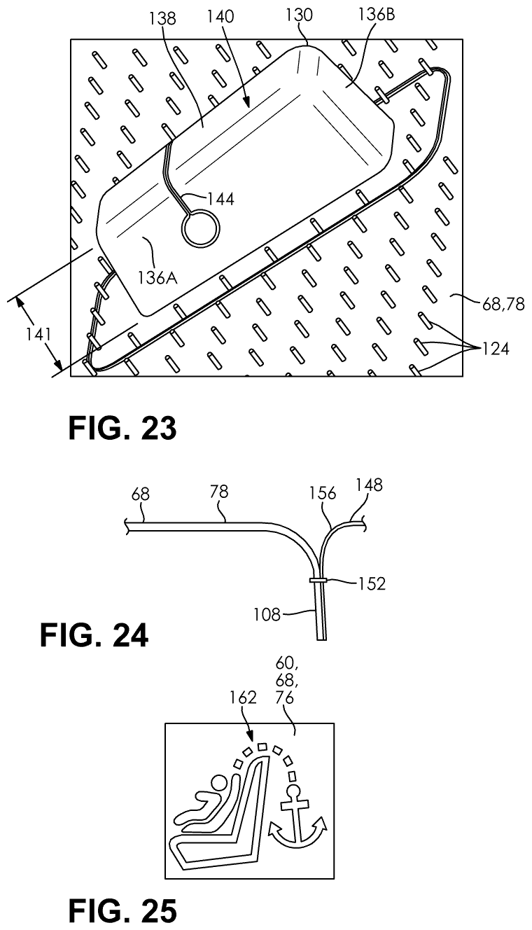

The extensions 124 may be approximately the same size and shape as one another. The extensions 124 may be shaped as spikes, cones, parts of cones, and/or hemispheres that may be generally equally spaced from one another. While some shapes are mentioned with certain spacing, others may be permissible. FIGS. 21-23 schematically depict the extensions as a plurality of equally spaced apart rods or tubes in columns and/or rows extending from the second side 78.

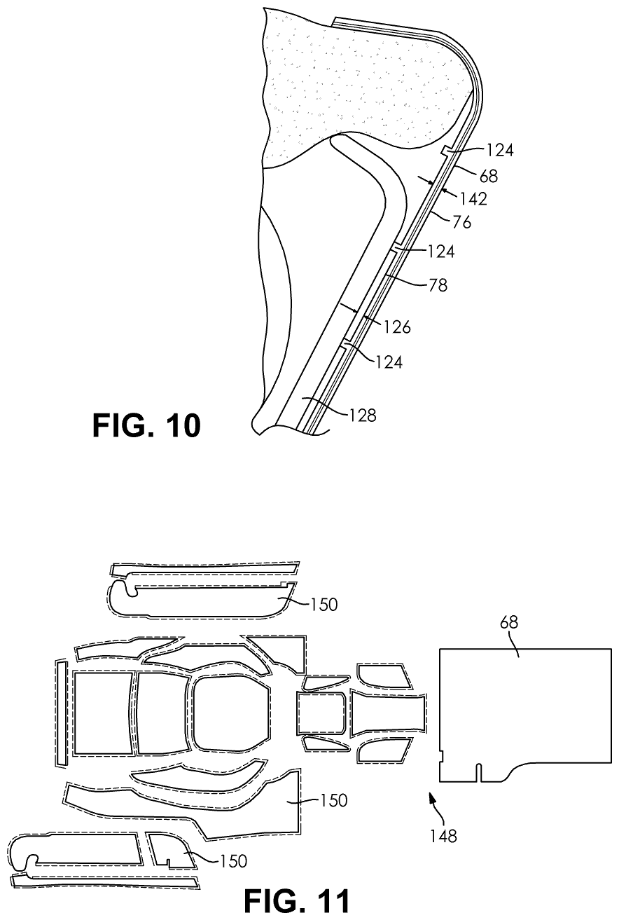

The extensions 124 may extend approximately 1 mm from the second side 78 of the coated base material 68. They may function to locate the coated base material 68 a set distance 126 from a seat component 128, such as a frame member, as schematically depicted in FIG. 10. Thus, the one or more of the extensions 124 may be located in direct facing contact with the frame member 128 with no intervening structures. The seat component 128 may be constructed of plastic, metal and/or other materials. The extensions 124 may function to absorb and reduce vibrations and noise between the seat component 128 and the coated base material 68. Further, additional vibration and/or noise absorbing structures or layers may not be required between the seat component 128 and the coated base material 68.

The extensions 124 may not be used. Instead, one or more pieces of non-woven material may be located on the second side 78 of the coated base material 68. In other cases no additional non-woven materials are needed and the coasted base material 68 may be in direct contact with the seat component 128. The flexible, elastic nature of the non-woven material may be sufficient on its own to absorb and reduce vibrations and noise.

FIGS. 9A, 9C, 9D, 9G1 and 9G2 schematically depict a pocket 130 in the body portion 92 of the coated base material 76. The pocket 130 may be of any size, shape and/or depth including generally rectangular. The pocket 130 may be defined by transition portions 132 about its perimeter portion 134 that may be radiused edges. The transition portions 132 extend to walls 136 that define the pocket 130. In an exemplary embodiment, the walls 136 may be such as two parallel long wall portions 136A and two parallel short wall portions 136B extending transverse the long wall portions 136A. The long wall portions 136A may be generally the same height, width and depth as one another and the short wall portions 136B may be generally the same height, width and depth as one another. The walls 136 may all connect to a base portion 138, such as by radiused transitions 140. The pocket 130 may extend below the first side 76 to a depth 141 that may be greater than an overall depth 142 of the body portion 92 and/or the back panel 50 or whatever the shape of the coated base material 68 may be formed into. The pocket 130 may not have any texturing 120 associated with it, however, graining 122 may be added.

There may be a slot 144 through the base portion 138 and/or some of the walls 136. The slot 144 may extend generally in the base portion 138 and at least partially into the long wall portions 136, thus, the slot 144 may be generally parallel the short wall portions 136B.

The slot 144 may be adapted to selectively receive a seat component 146 therein. The seat component 146 may be such as an anchor bar for a child safety seat tether. The flexible nature of the coated base material 76 elastically moves out of the way and lets the seat component 146 to be pushed through the slot 144. The walls 136 and/or the base portion 138 may elastically enclose and surround the seat component 146.

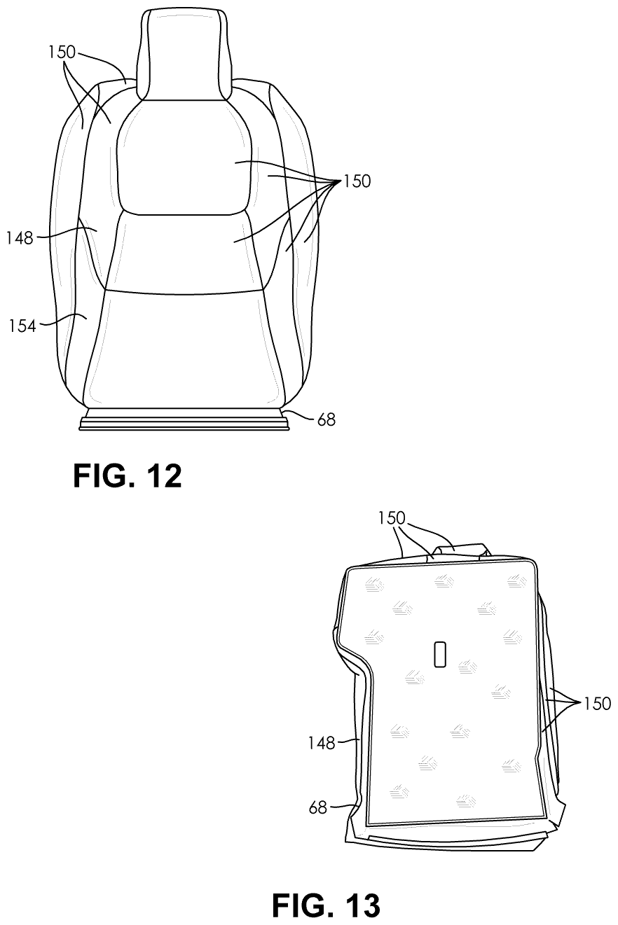

FIGS. 11-15 schematically depict the connection of the coated base material 68 to a seat cover 148. FIG. 11 is an exemplary embodiment of individual panels 150 associated with a seat cover 148, and the back panel 50 that will attach to them. FIGS. 12 and 13 schematically depict the assembled panels 150 connected to the coated base material 68. The panels 150 are flexible and may collapse on the back panel 50 without any support. FIG. 13 depicts the coated base material 68 extending substantially the length and width of the seat cover 148 and connected thereto. The connection may be such as by stitching 152. The stitching 152 connection of the back panel 50 to the seat cover 148 may not be visible. As schematically shown in FIG. 12, which depicts the A-side 154 of the seat cover 148, or the side facing the occupant, the stitching 152 connecting the back panel 50 and the seat cover 148 cannot be seen.

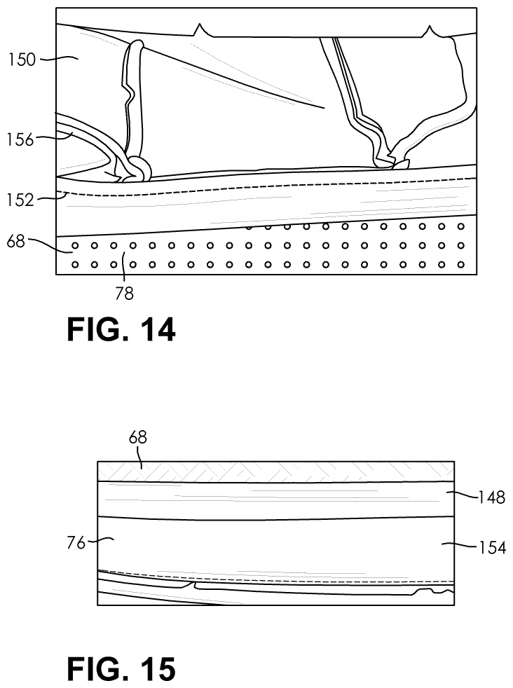

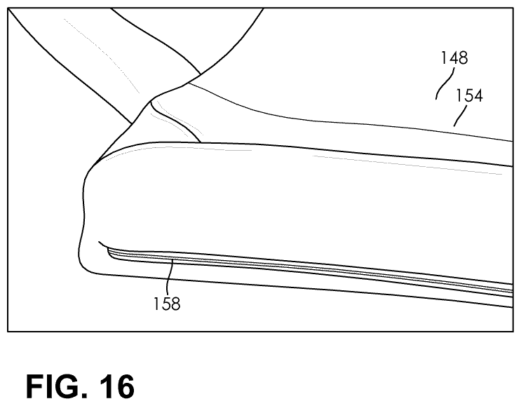

FIG. 14 schematically depicts one area of an inside surface 156 of the seat cover 148 and the second side 78 of the coated base material 68 connected together. This may be referred to as the B-side 78 of the coated base material 68 or the side 156 opposite the side 154 facing the occupant/interior. This side 156 typically is not observable by the occupant. The figure schematically depicts a continuous, single line of stitching 152 that may be used to extend from the flange portion 108 of the coated base material 68 to the seat cover 148 to connect them together without any intervening structures. FIG. 15 schematically depicts the A-side 154 of the seat cover 148 and coated base material 68 connection compared with FIG. 14 where the stitching 152 cannot be observed. FIG. 15 depicts the A-side 154 of the seat cover 148 and coated base material 68 which is typically observable by the occupant.

The flexible, elastic nature of the coated base material 68 permits the use of a continuous, single line of stitching 152. For example, the coated base material 68 can be bent back, partially or fully onto itself, and/or twisted so that the perimeter edge portion 106 of the coated base material 68 can be aligned with a perimeter edge of the seat cover 148 and with a sewing machine needle. The resilient nature of the coated base material 68 may permit it to return to its original shape and orientation.

FIG. 24 schematically depicts stitching 152 the seat cover 148 and the coated base material 68. The inside surface 156 of the seat cover 148 and the second side 78 of the coated base material may be directly connected together without any intervening structures via stitching 152. The stitching 152 may extend through the flange portion 108 of the coated base material 68, or simply the coating 60, and into the seat cover 148 to secure them together.

The nonwoven material may assist in holding the coated base material 68 to the cover 148. Namely, the random size, shape and/or location of the fibers in the nonwoven material may prevent the stitching 152 from moving within, or through such as in a tearing action, the non-woven material. Thus, the non-woven material may eliminate or reduce tearing of the coated base material 68, the cover 148 or other structures attached to the coated base material 68, which may include selectively closeable devices. FIG. 16 schematically depicts the A-side 154 of the seat cover 148 installed. The seat cover 148 and coated base material 68 may be further connected by a selectively closable device, such as a zipper 158 (shown), hook and loop fasteners, mechanical devices (such as snaps or buttons) or the like.

The coated base material 68 may have a Shore A hardness of between approximately 60-68, preferably 64, a weight of approximately 2000 g/m2 and a thickness of approximately 2.7 mm.

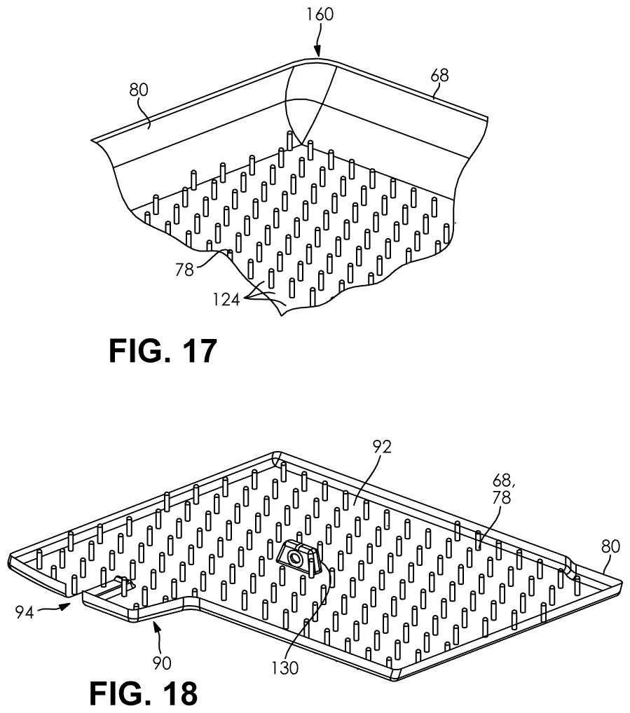

FIG. 17 is a lower perspective schematic view of the coated base material 68 depicting an outer corner 160. Being a lower view, the second side 78 of the coated base material 68 is visible. FIG. 18 depicts the coated base material 68, with the corner 160, including the second side 78 of the coated base material 68.

The depicted outer corner 160 may be the same as all the corners or just some. The outer corner 160 may be part of the perimeter edge 80 comprising the transition portion 106 and the flange 108. The corner 160 may have a radius of approximately X mm to Y mm. As noted above, the outer corner 160 may be comprised of just the coating 60 without any base material 52.

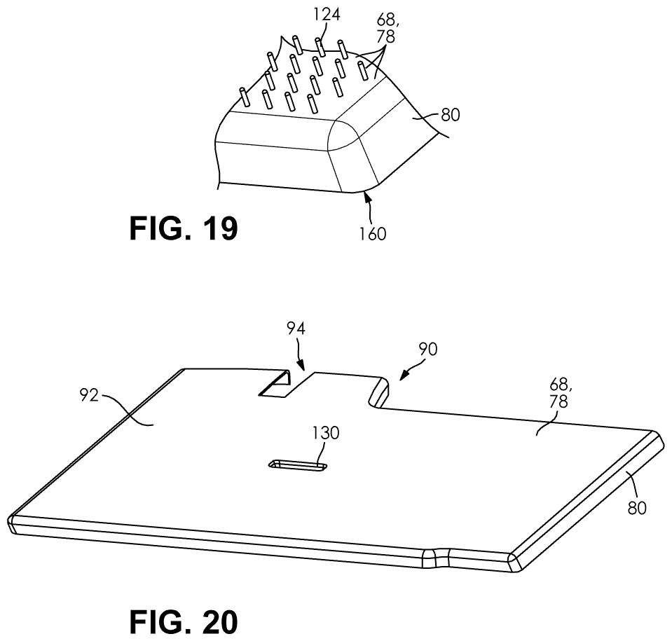

FIG. 19 is an upper perspective schematic view of an inner corner, which may be the same corner as 160. Being an upper view, the first side 76 of the coated base material 68 is visible. The figure further supports the features of the corner 160 discussed above. FIG. 20 depicts the coated base material 68, with the corner 160, including the first side 76 of the coated base material 68.

The outer corner 160, and thus the perimeter edge 80, may be upstanding from the body portion 92 of the coated base material 68. The outer corner 160 and the perimeter edge 80 may form a substantially continuous rim about body portion 92. The rim may be substantially uniform in size, shape, height and width about the body portion 92.

FIG. 25 schematically depicts an image 162 in or on the coating 60 and/or the coated base material 68. The image 162 may be located on the first side 76 of the coated base material 68. The image 162 may comprise a logo indicating a location. The location may be, but is not limited to, an attachment point for a child safety seat. The image may also comprise a QR code, serial number or the like that may assist with part tracking and/or quality control. In those cases, the image 162 may be located on the second side 78 of the coated base material 68 so that it is not readily observable by occupants.

In accordance with the provisions of the patent statutes, the present device has been described in what is considered to represent its preferred embodiments. However, it should be noted that the device can be practiced otherwise than as specifically illustrated and described without departing from its spirit or scope.

What is claimed is:

1. A part for a vehicle seat, comprising:
a base material comprised of a flexible, non-woven material, wherein the base material has a polymeric coating on at least part of the base material, and
wherein a trim piece is sewn to the coated base material.

2. The part of claim 1, wherein the coated base material has a perimeter edge portion with an undercut.

3. The part of claim 1, wherein the coated base material is a back panel for a seat back and the trim piece is a seat cover.

4. The part of claim 1, wherein the coating is approximately 0.5 mm to 2 mm thick on the base material.

5. The part of claim 1, wherein the coating is a polymer comprising polyurethane.

6. The part of claim 1, further comprising an image on the polymeric coating, wherein the image comprises a logo indicating a location of an attachment point for a child safety seat.

7. The part of claim 1, wherein the coated base material has a recess and a pocket, wherein a thickness of the coated base material is less than a thickness at the recess and the pocket compared with a body portion of the coated base material.

8. The part of claim 1, wherein a perimeter edge portion extends at an acute angle to a body portion of the coated base material.

9. The part of claim 1, wherein a plurality of extensions are on one side of a body portion of the coated base material.

10. The part of claim 1, wherein a pocket that is one piece, integrally formed and unitary with a body portion of the coated base material extends outwardly from the body portion.

11. The part of claim 10, wherein a slot extends through a base portion of the pocket.

12. The part of claim 1, wherein the polymeric coating has portions without the non-woven material.

13. The part of claim 1, wherein the polymeric coating comprises a Shore A hardness between 60-68.

14. The part of claim 1, wherein the polymeric coating comprises a base portion, a first flange, a second flange and a rounded corner joining the base portion, the first flange and the second flange.

15. The part of claim 14, further comprising stitching coupling the first flange to a trim piece, wherein the first flange is angled from the base portion of the polymeric coating to hide the stitching.

16. The part of claim 14, wherein the base material does not extend into a least one of the first flange or the second flange.

17. A method of forming a part for a vehicle seat, comprising,
providing a polymeric coating on a non-woven base material,
forming surface features on the coated base material, wherein the surface features comprise at least one of a recess, a pocket, graining, texturing and a plurality of extensions, and
sewing a trim piece to a perimeter edge portion of the coasted base material.

18. The method of claim 17, wherein an edge portion of the coated base material is selectively bent adjacent a base portion of the coated base material to align the edge portion with the trim piece for sewing.

19. The method of claim 18. wherein the edge portion returns to an acute angle with respect to a body portion after sewing.

20. A seat for a vehicle comprising the part of claim 1, wherein the seat is configured to fold from a use position to a flat position. wherein the coated base material is configured to provide a floor in the flat position.
